(19) United States
(12) Patent Application Publication
(10) Pub. No.: US 2026/0275653 A1
(43) Pub. Date: Sep. 17, 2026

(54) APPARATUS AND METHOD FOR MAKING MOLDED PULP PRODUCTS FROM NANOCELLULOSE FIBERS

(71) Applicants: Claudia Lowd, Orono, ME (US); Ariadne Dimoula, Westbrook, ME (US); University of Massachusetts, Boston, MA (US)

(72) Inventors: Claudia Lowd, Orono, ME (US); Ariadne Dimoula, Westbrook, ME (US); Chen-lu Yang, Westport, MA (US); Edward Spring, Rehoboth, MA (US)

(21) Appl. No.: 19/231,458

(22) PCT Filed: Dec. 8, 2023
(86) PCT No.: PCT/US2023/083254

§ 371 Date: Jun. 7, 2025

Related U.S. Application Data
(60) Provisional application No. 63/431,587, filed on Dec. 9, 2022.

(51) Int. Cl. D21J 3/10

(52) U.S. Cl. CPC D21J 3/10

(57) ABSTRACT

An apparatus and method for making a molded two-dimensional or three-dimensional pulp product using nanocellulose fibers. The apparatus includes a mold base, a guide ring, a filtration screen, and a mold. The guide ring removably affixed to the mold base and retains the filtration screen. The mold is of selectable configuration and may include an interior groove. The interior groove is arranged to retain the fibers of a suspension thereto when the mold is pressed to remove fluid from the suspension so that shrinkage of the molded product is minimized. When pressure is released from the mold, extrudate of the pressed fibers remains in the interior groove. The extrudate may be cut away to leave the molded pulp product of a desired size and configuration. The interior groove may not be needed in forming two-dimensional products.

### BACKGROUND OF THE INVENTION

### 1. Field of the Invention

The present invention relates to molded products made from pulp and the apparatus and method for making such products from nanocellulose fibers. More particularly, the present invention relates to the construct of mold components and steps in the manufacturing process to form two-dimensional and three-dimensional pulp products that substantially retain their dimensions after molding.

### 2. Description of the Prior Art

Molded pulp products (MPP) are primarily used for the packaging of manufactured products or for food related carriers, such as food containers and serving trays. Due to poor mechanical properties, MPPs have been restricted to limited fields of application. However, demand is increasing due to their renewable and biodegradable qualities. These qualities have enabled growing adoption within the packaging industry, with companies eager to embrace alternatives to petroleum-based forms of packaging due to government regulations as well as customer demands.

Derived from wood fiber (pulp), compositions formed of cellulose nanofiber (CNF) resemble plastics in many aspects, such as high mechanical strength, stiffness, and optical transparency. The nanofibers bond together well enough without a chemical adhesive to form a product with sufficient structural integrity to compete with similar plastics-based products. Because of that, CNF has a potential to be a sustainable, renewable, and eco-friendly replacement of petroleum-based plastics.

Prior attempts to fabricate MPP from CNF have not been successful. Processes for making CNF generate a water suspension of fibers wherein the solids content of the suspension may be as low as 3%. Even at that low solids composition, the CNF water suspension is viscous that it is a gel-like semi-solid material rather than a low-viscosity liquid. As a result, it can be difficult to dewater the material before or during molding. Specifically, it is difficult to filter the CNF suspension through filtration cloth given the gel-like quality of the suspension. Vacuum filtration is also of limited value, again to the highly viscous nature of the CNF gel.

In view of the limited effect of cloth filtration or vacuum filtration, it can be difficult to mold dimensionally-stable CNF products because of the difficulty in removing water from the suspension. Extensive hydrogen bonding between individual fibers causes the desired molded object to shrink in the drying process. The shrinkage is greatly enhanced by faster water evaporation at the surface of the composition used to form a product than within the material, as well as the moisture gradient created in the cellulosic object.

CNF pulp was developed more than thirty years ago. To this day, there is still no technology available to produce commercially viable three-dimensional objects of CNF that substantially retain their dimensions after manufacturing completion. What is needed is a way to produce CNF-based three-dimensional products. In particular, what is needed is a manufacturing method and related manufacturing equipment capable of enabling the manufacture of commercially viable three-dimensional objects of CNF that substantially retain their dimensions after manufacturing completion.

### SUMMARY OF THE INVENTION

It is an object of the present invention to produce CNF-based three-dimensional products. In particular, it is an object of the present invention to provide a manufacturing method and related manufacturing equipment capable of enabling the manufacture of commercially viable three-dimensional objects of CNF that substantially retain their dimensions after completion of the manufacturing process. It is also an object of the present invention to produce CNF products that may be two-dimensional, such as flat products that may be used as such or formed into other products.

The present invention is a molding apparatus and a manufacturing method that together produce commercially viable, environmentally friendly, CNF-based molded products. The apparatus and method effectively remove water from a CNF suspension and minimize molded product shrinkage.

The apparatus includes a wire cloth screen, a mold with a product release portion and a product retention portion, and a press to facilitate water removal uniformly through the suspension. The release (non-sticking) portion of the mold is arranged to prevent sticking of a portion of the molded product to the mold and the retention (sticking) portion is arranged to removably affix a portion of the molded product to the mold. The release portion ensures that the molded product can be separated from the mold upon completion of the manufacturing method. The retention portion limits shrinkage of the CNF-based composition used to make the product throughout the molding process. Upon completion of the molding process, the molded product is detached from the retention portion of the mold in substantially the configuration intended. The mold includes a groove at a perimeter thereof where excess CNF material flows during the molding stage of the manufacturing method. That excess material is restrained in the groove, thereby preventing contraction and shrinkage as the CNF suspension is converted into a 3D solid object.

The manufacturing method limits the extent of composition shrinkage that otherwise occurs due to excess moisture retention trapped in the body of the product at its surfaces that contact a heated mold. The manufacturing method includes the steps of filtering water from a CNF suspension to increase the solids content of the suspension and then pressing the filtered composition to remove an additional portion of the water from the suspension to further increase the solids content thereof to the point where enough CNF is isolated from water to proceed with it prior to heating in the mold. The composition may be pressed while in the mold prior to heating the mold. It may also be pressed prior to insertion in the mold.

In an embodiment of the invention for making three-dimensional products, primary components of the apparatus of the present invention include a guide ring to create a chamber that is a mold to control the amount of the CNF material thus the thickness of the MPP, a screened/sintered material that allows water to pass through yet efficiently retain all the nanofiber, and a piston with an area with special surface/geometry to hold the fiber material thereon in a three-dimensional configuration in order to prevent/or manage shrinking during heating/drying. The apparatus and method of the present invention for the first embodiment resolve the problems that have been encountered for many years in the attempt to make commercially viable 3D products with plastics-equivalent characteristics without the undesirable limitations associated with plastic products. In another embodiment of the invention for making two-dimensional products, the mold and screen combination are substantially of uniform shape, such as a flat rectangle, and a piston that is also substantially flat so that when engaged with the mold, retains the CNF material on the screen in a flat, essentially two-dimensional form. Details of representative embodiments of the embodiments of the apparatus and the method are further described herein.

### BRIEF DESCRIPTION OF THE DRAWINGS

FIG. 1 is a top perspective view of the mold apparatus of a first embodiment of the present invention with primary components separated from one another.

FIG. 2 is a side view of the molding blank of the mold apparatus of FIG. 1.

FIG. 3 is a perspective view of the mold apparatus of FIG. 1 pulled apart and showing a dimensionally stable example 3D MPP made with CNF.

FIG. 4 is an exploded view of the mold apparatus of FIG. 1 of the present invention.

FIG. 5 is a flow diagram listing primary steps of the molding method of the present invention.

FIG. 6 is a top perspective view of a second embodiment of the mold apparatus of the present invention for making flat (i.e., two-dimensional (2D)) product.

FIG. 7 is a top perspective view of the mold apparatus of FIG. 6 with the primary components joined together.

FIG. 8 is a top perspective view of the mold apparatus of FIG. 6 pulled apart and showing a dimensionally stable example of a 2D product made with CNF.

FIG. 9 is an exploded view of the mold apparatus of FIG. 6.

### DETAILED DESCRIPTION OF THE INVENTION

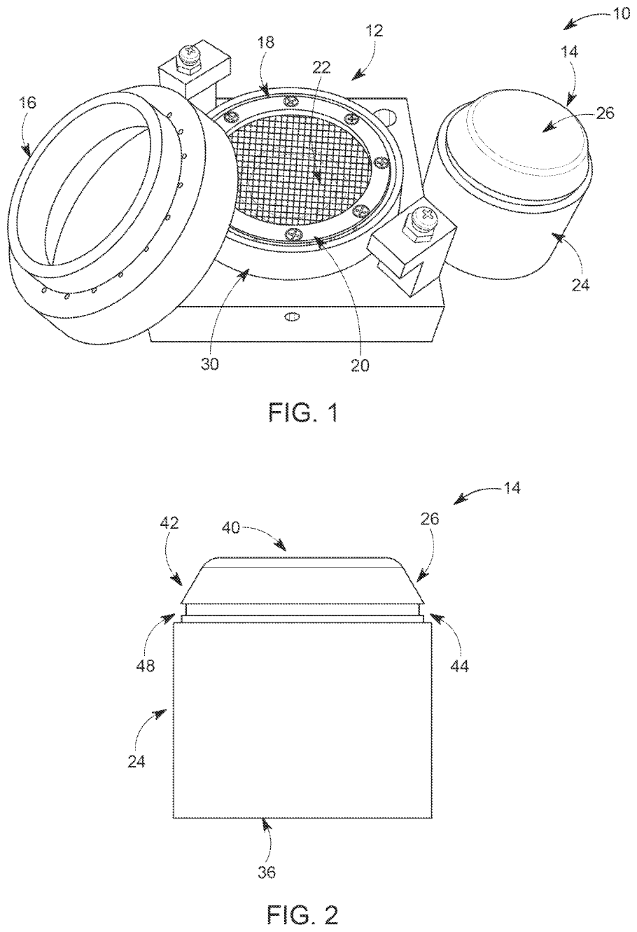

As illustrated in FIGS. 1-4, a first embodiment of a mold apparatus 10 of the present invention for making a three-dimensional molded pulp product includes a mold base 12, a molding blank 14, and a guide ring 16. The mold base 12 includes a water retention tray 18, a support screen 20, and a filtration screen 22. The molding blank 14 includes a plunger body 24 and a mold 26. The guide ring 16 includes a mold cap 28.

The filtration screen 22 is a wire cloth. The wire cloth may be stainless steel but not limited thereto. Openings of the filtration screen 22 are selectable. The openings of the wire cloth are chosen to enable the removal of water or other fluid from a CNF suspension or paste while retaining at least a portion of the CNF solids from that suspension. In one example, the openings are about 26 micrometers for a 200×600 screen size but not limited thereto. A suitable wire cloth for the filtration screen 22 is available from McMaster-Carr of Elmhurst, Illinois.

The support screen 20 is removably affixed to a perimeter 30 of the mold base 12 and provides structural support to the filtration screen 22 while allowing water to pass therethrough into the water tray 18. The support screen 20 is a perforated base having sufficient mechanical strength to retain the filtration screen 22 in place while pressure is applied to it by the molding blank 14. The pressure applied is substantially uniform and should be in the range of about 25 psi to about 150 psi.

The guide ring 16 is removably affixed to the perimeter 30 of the mold base 12 and retains the filtration screen 22 and support screen 20 therebetween. The guide ring 16 is configured to standoff from the perimeter 30 of the mold base 12, establishing a molding chamber 32 over the filtration screen 22. The height of the chamber 32 is selectable dependent on the desired thickness of a three-dimensional cellulose nanofiber molded pulp product (3D CNF MPP) 34 to be made. The guide ring 16 is designed to guide the molding blank 14 into the mold base 12 in substantial alignment so that pressure applied to the molding blank 12 is substantially equivalent through to the filtration screen 22.

The molding blank 14 includes the plunger body 24 and the mold 26. The plunger body 24 includes a bottom 36 that is substantially flat so that uniform pressure applied thereto is substantially uniformly transferred to the filtration screen 22 when the molding body 14 is inserted into the guide ring 16. The plunger body 24 is shown as a cylinder but its configuration is not limited to a cylinder. A bottom 38 of the mold 26 is permanently or removably affixed to a top 40 of the plunger body 24. The mold 26 includes a tapered upper portion 42 and a groove 44 between the tapered upper section 42 and the top 40 of the plunger body 24. The angle of the tapered upper portion 42 of the mold 26 is selectable. It is designed to generate a desired interior shape of the 3D CNF MPP 34 and to facilitate removal of the 3D CNF MPP 34 from the mold 26 when the molding process is complete.

The mold 26 of the molding blank 14 is made of, or treated with, a material that is a release material selected to minimize adhesion of a main body 46 of the 3D CNF MPP 34 thereto. For example, the mold 26 may be made of stainless steel and treated with a release agent such as a silicone oil but not limited thereto. At least an interior portion 48 of the groove 44 is made of, or treated with, a material that is a retention material selected to enhance adhesion of at least a portion of a perimeter ring 50 of the 3D CNF MPP 34 thereto. This configuration of the mold 26 with a release portion and a retention portion ensures that the 3D CNF MPP 34 maintains dimensionally stability through completion of the fabrication process while being releasable from the mold 26 with little to no destruction of the body or surface thereof. The material of the retention portion may be tile, glass, enamel, ceramic, or tape, but not limited thereto.

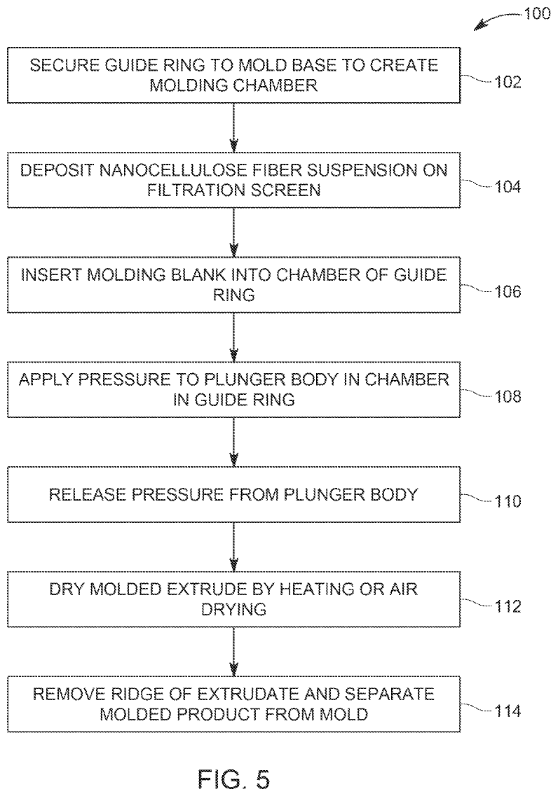

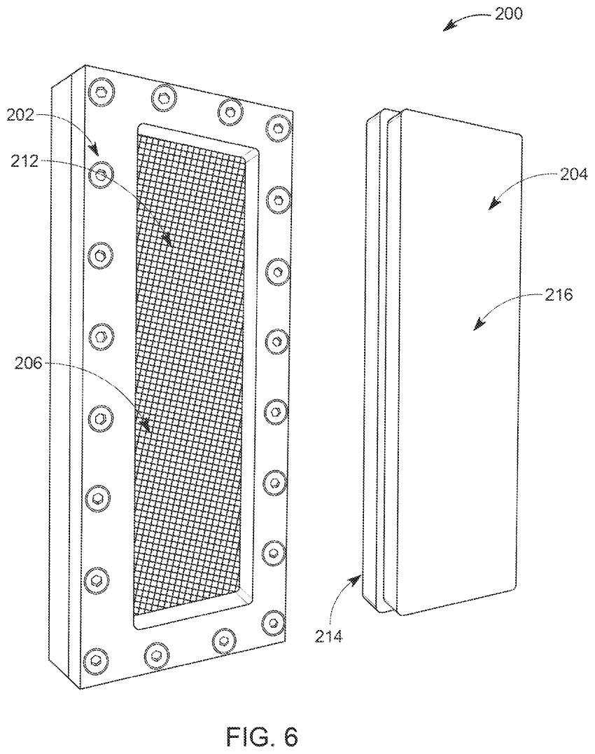

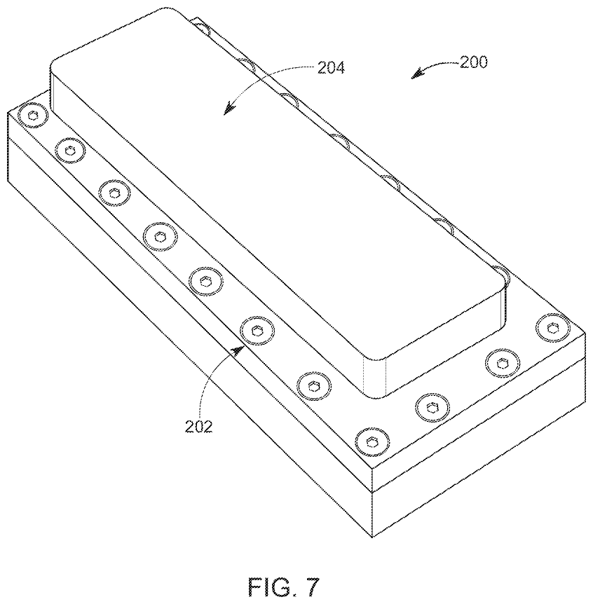

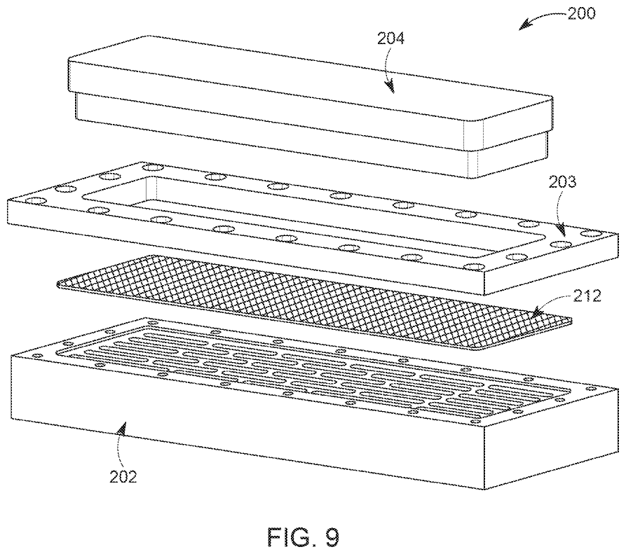

A method 100 of making the 3D CNF MPP 34 includes a set of primary steps described in view of FIG. 5. The method 100 includes a first step 102 of removably securing the guide ring 16 to the mold base 12 to create the molding chamber 32 spaced from suspension on the filtration screen 22. The method 100 includes a second step 104 of depositing a water suspension of nanocellulose fibers on the filtration screen 22 in the mold base 12. The filtration screen 22 is positioned on the support screen 20 before introduction of the suspension. The suspension of nanocellulose fibers may include one or more other components including, but not limited to, other structural materials that may be cellulosic or other materials that are not nanofibers, and one or more additives selected to impart to the 3D CNF MPP 34 one or more characteristics of interest. The method 100 may also be used to make a 2D product as described with respect to FIGS. 7-9.

In step 106, the molding blank 14 is inserted into the chamber 32 of the guide ring 16, with the mold 26 in contact with, or almost in contact with, the suspension on the filtration screen 22. In step 108, pressure is applied to the bottom 36 of the plunger body 24. The pressure applied to the plunger body 24 forces the mold 26 to apply a substantially uniform pressure to the suspension. The pressure applied to the suspension forces water from the suspension through the filtration screen 22 and the support screen 20 into the water tray 18 of the mold base 12. The pressure applied to the suspension also extrudes the suspension, which has an increasing solids content as water is forced out of it, in the chamber 32.

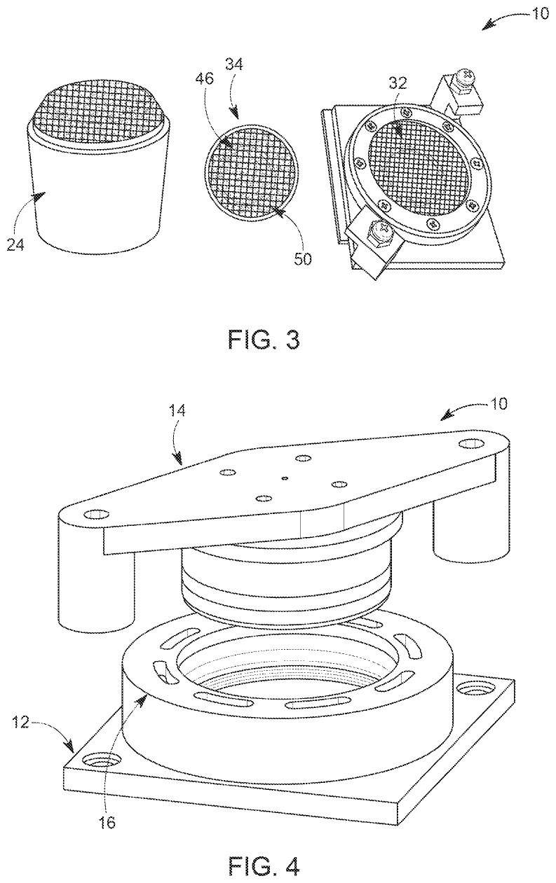

The extruded suspension substantially forms the extrudate, which may also be referred to as a CNF mat, into a shape mirroring that of the shape of the mold 26. An excess of the extrudate extends around the mold 26 into the groove 44. A precursor of the 3D CNF MPP 34 is formed, with a first portion mirroring the shape of the mold 26 and a second portion forming a ridge within the groove 44. The retention feature of the groove 44 retains the formed ridge thereto and its connection to the first portion of the precursor forces that first portion to substantially retain the mirror shape of the mold 26. The amount of pressure applied to the plunger body 24 and the time period of pressure application are selectable. In one example of the method 100, the pressure applied was about 30 psi for a time period of about five minutes, resulting in the 3D CNF MPP 34 shown in FIG. 3.

In step 110 of the method 100, the pressure is released from the plunger body 24. The apparatus 10 is then either heated at a selectable temperature or allowed to stand at room temperature for a selectable period of time to enable drying of the extrudate, step 112. Inward forces created by contraction and shrinkage of the drying extrudate makes the extrudate stick tightly to the mold 26 while the ridge in the groove 44 maintains the molded dimensions of the extrudate. The guide ring 14 may be removed from the mold base 12 before or after completion of the drying of the extrudate. In step 114, the ridge of the extrudate is cut from the first portion thereof so that only the first portion remains and is separated from the mold 26. The result of the method 100 is production of a three dimensional dimensionally stable finished product formed of nanocellulose fiber, such as the 3D CNF MPP 34 of FIG. 3.

The combination of the apparatus 10 including the mold groove 44 with retention characteristic with the method 100 including press filtration of the suspension rather than using vacuum filtration yields a dimensionally stable 3D CNF product suitable for commercialization without the inherent limitations associated with the manufacturing of similarly shaped plastic products. In the fabrication of the 3D CNF MPP 34 example described, the resultant product yielded effect characteristics. The fabricated product was a container that held water for up to about 20 hours without leaking while no other coating such as a waterproof coating was applied to it. The sample product also held oil for more than six days without change or leakage and it held butter for more than six days without change or leakage. The 3D CNF MPP is microwavable and can be frozen, both without substantial distortion.

As illustrated in FIGS. 6-9, a second embodiment of a mold apparatus 200 of the present invention for making a two-dimensional molded pulp product includes a mold base 202 and a molding blank 204. The mold base 202 may include a water retention tray and a support screen as described with respect to the apparatus 10. The mold apparatus 200 includes a filtration screen 212. The molding blank 204 includes a plunger body 214 and a plunger base 216.

The filtration screen 212 is a wire cloth. The wire cloth may be stainless steel but not limited thereto. Openings of the filtration screen 212 are selectable. The openings of the wire cloth are chosen to enable the removal of water or other fluid from a CNF suspension or paste while retaining at least a portion of the CNF solids from that suspension. In one example, the openings are about 26 micrometers for a 200×600 screen size but not limited thereto. A suitable wire cloth for the filtration screen 212 is the same one suitable for the filtration screen 22 of the first embodiment of the invention but not limited to that material. The filtration screen 212 is removably secured to the mold base 202 with a mold frame 203.

The support screen may be perforated, as noted, and of sufficient mechanical strength to retain the filtration screen 212 in place while pressure is applied to it by the molding blank 204. The pressure applied is substantially uniform and should be in the range of about 25 psi to about 150 psi.

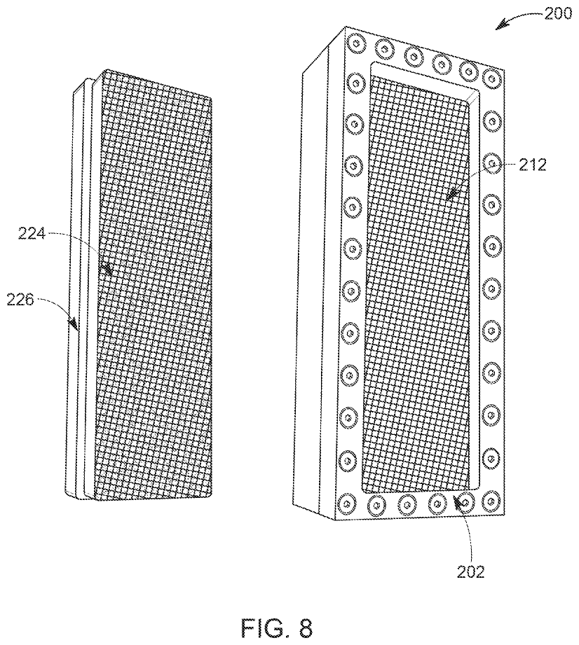

An interior space 206 of the mold base 202 having the filtration screen 212 as its bottom has a depth that is greater than a thickness of the plunger body 214. A gap formed between a bottom of the plunger body 214 and the filtration screen 212 establishes a molding chamber of the apparatus 200 when the molding blank 204 is placed on the mold base 202 as shown in FIG. 8. It is in that molding chamber that a two-dimensional cellulose nanofiber molded pulp product (2D CNF MPP) 224 is formed. In order to establish the gap between the plunger body 214 and the filtration screen 212, the plunger base 216 has an exterior perimeter that is greater than an interior perimeter of the interior space 206 of the mold base 202. The gap between the plunger body 214 and the filtration screen 212 is greatest when the CNF is placed on the filtration screen 212 and before any pressure is applied to the molding blank 204 when the molding base 204 is positioned on the mold base 202. When pressure is applied to the molding blank 204, fluid is squeezed from the CNF through the filtration screen 212 and the gap is reduced. When the molding blank 204 makes contact with the mold base 202, the gap is the smallest and the gap height then defines the thickness of the product 224. The thickness of the product 224 is thereby selectable based on the thickness of the plunger body 214 and the pressure applied to the molding blank 204.

As noted, the molding blank 204 includes the plunger body 214 and the plunger base 216. The plunger body 214 includes a bottom 226 that is substantially flat so that uniform pressure applied thereto is substantially uniformly transferred to the filtration screen 212 when the plunger body of the molding body 204 is inserted into the mold base 202. The plunger body 214 is shown as a rectangle but its configuration is not limited to a rectangle. A bottom of the plunger base 216 is permanently or removably affixed to a top of the plunger body 214. The mold base 202 is essentially square on its interior sides, and sides of the plunger body 214 are substantially orthogonal to the top rather than tapered and closely dimensioned to fit within the interior space 206 of the mold base 202. This ensures that the CNF on the filtration screen 212 is molded into a flat shape rather than a 3D form.

The bottom 226 of the plunger body 216 is made of, or treated with, a material that is a release material selected to minimize adhesion of the 2D CNF MPP 224 thereto. The interior walls of the mold base 202 and the sides of the plunger body 216 may also be so treated. For example, the plunger body 216 and the interior of the mold base 202 may be made of stainless steel and treated with a release agent such as a silicone oil but not limited thereto. The interior walls of the mold base may alternatively be treated or made with a material that is a retention material selected to enhance adhesion of at least a portion of a perimeter of the 2D CNF MPP 224 thereto. This configuration of the mold base 202 with a retention portion ensures that the 2D CNF MPP 224 maintains dimensionally stability through completion of the fabrication process while being releasable from the mold base 202 and the molding blank 204 with little to no destruction of the body or surface thereof. The material of the retention portion may be tile, glass, enamel, ceramic, or tape, but not limited thereto.

While the invention has been described with specific reference to particular components of the apparatus 10, the apparatus 200, and the method 100 and particular details thereof, it is to be understood that the invention includes all reasonable equivalents.

What is claimed is:

1. An apparatus for making a three-dimensional molded pulp product using nanocellulose fibers in a fluid, the apparatus comprising:
a mold base having a perimeter;
a guide ring affixed to the perimeter of the mold base;
a filtration screen retained between the mold base and the guide ring; and
a mold of selectable configuration removably connected to the guide ring, wherein the mold includes an interior groove,
wherein the guide ring is configured to stand off from the mold base to establish a molding chamber between the mold base and the mold for receiving therein the fluid with the nanocellulose fibers, and
wherein the filtration screen is arranged to enable the fluid to pass from the chamber while holding in the chamber at least a portion of the nanocellulose fibers when pressure is applied to the mold to press those nanocellulose fibers to form the molded pulp product in the chamber, and
wherein the interior groove of the mold has a surface arranged to keep the nanocellulose fibers retained thereto while forming the molded pulp product to minimize shrinkage thereof while forming.

2. The apparatus of claim 1, further comprising a support screen to support the filtration screen, wherein the support screen is affixed between the mold base and the guide ring.

3. The apparatus of claim 1, wherein the mold base includes a water retention tray.

4. The apparatus of claim 1, further comprising a plunger body connected to the mold to enable the application of pressure to the mold, wherein the plunger body is tapered.

5. The apparatus of claim 1, wherein the mold is made of stainless steel.

6. The apparatus of claim 5, wherein the surface of the interior groove of the mold is at least partially made of or treated with tile, glass, enamel, ceramic, or tape.

7. A method for making a three-dimensional molded pulp product of nanocellulose fibers using an apparatus including a mold base, a guide ring, and a filtration screen, the method comprising the steps of:
securing the guide ring to the mold base to create a molding chamber spaced from the filtration screen;
depositing a fluid suspension of the nanocellulose fibers on the filtration screen in the mold base;
inserting a mold into the guide ring to contact the suspension on the filtration screen, wherein the mold includes an interior groove with a surface arranged to retain the nanocellulose fibers thereto;
applying a substantially uniform pressure to the mold so that compressed nanocellulose fibers on the filtration screen extend into the interior groove to form the molded pulp product;
releasing the pressure applied to the mold for a selectable period of time; and
removing the mold and the guide ring to extract the molded pulp product from the mold base.

8. The method of claim 7, further comprising the step of forming or treating the interior groove of the mold with tile, glass, enamel, ceramic, or tape prior to inserting the mold into the guide ring.

9. The method of claim 7, wherein the pressure applied to the mold is about 30 psi and the pressure is released after about five minutes.

10. The method of claim 7, further comprising the step of cutting away from the molded pulp product extrudate retained in the interior groove of the mold.

11. An apparatus for making a two-dimensional molded pulp product using nanocellulose fibers in a fluid, the apparatus comprising:
a mold base having a perimeter;
a guide ring affixed to the perimeter of the mold base;
a filtration screen retained between the mold base and the guide ring; and
a mold of selectable configuration removably connected to the guide ring, wherein the mold,
wherein the guide ring is configured to stand off from the mold base to establish a molding chamber between the mold base and the mold for receiving therein the fluid with the nanocellulose fibers, and
wherein the filtration screen is arranged to enable the fluid to pass from the chamber while holding in the chamber at least a portion of the nanocellulose fibers when pressure is applied to the mold to press those nanocellulose fibers to form the molded pulp product in the chamber,
wherein the molding chamber is of substantially uniform dimension, and
wherein at least a portion of the molding chamber has a surface arranged to keep the nanocellulose fibers retained thereto while forming the molded pulp product to minimize shrinkage thereof while forming.

12. The apparatus of claim 11, further comprising a support screen to support the filtration screen, wherein the support screen is affixed between the mold base and the guide ring.

13. The apparatus of claim 11, wherein the mold base includes a water retention tray.

14. The apparatus of claim 11, further comprising a plunger body connected to the mold to enable the application of pressure to the mold, wherein the plunger body is substantially flat.

15. The apparatus of claim 11, wherein the mold is made of stainless steel.

16. The apparatus of claim 15, wherein the surface of the molding chamber is at least partially made of or treated with tile, glass, enamel, ceramic, or tape.

17. A method for making a two-dimensional molded pulp product of nanocellulose fibers using an apparatus including a mold base, a guide ring, and a filtration screen, the method comprising the steps of:
securing the guide ring to the mold base to create a molding chamber spaced from the filtration screen;
depositing a fluid suspension of the nanocellulose fibers on the filtration screen in the mold base;
inserting a mold into the guide ring to contact the suspension on the filtration screen, wherein the mold includes a surface arranged to retain the nanocellulose fibers thereto;
applying a substantially uniform pressure to the mold so that compressed nanocellulose fibers on the filtration screen to form the molded pulp product;
releasing the pressure applied to the mold for a selectable period of time; and
removing the mold and the guide ring to extract the molded pulp product from the mold base.

18. The method of claim 17, further comprising the step of forming or treating the interior of the mold with tile, glass, enamel, ceramic, or tape prior to inserting the mold into the guide ring.

19. The method of claim 17, wherein the pressure applied to the mold is about 30 psi and the pressure is released after about five minutes.

20. The method of claim 17, further comprising the step of cutting away from the molded pulp product extrudate retained in the interior of the mold.
